(19) United States
(12) Patent Application Publication
(10) Pub. No.: US 2018/0138995 A1
(43) Pub. Date: May 17, 2018

(54) APPARATUS AND METHOD FOR MEASURING BROADBAND PASSIVE INTERMODULATION DISTORTION SIGNAL

(71) Applicant: Electronics and Telecommunications Research Institute, Daejeon (KR)

(72) Inventors: Kyu-Min KANG, Daejeon (KR); Jae-Cheol PARK, Daejeon (KR); Seung-Keun PARK, Daejeon (KR); Sung-Jin YOO, Daejeon (KR); Hye-Yeon KWON, Daejeon (KR); Yun-Bae KIM, Daejeon (KR); Igor KIM, Daejeon (KR); Jung-Sun UM, Daejeon (KR); Young-Hwan LEE, Daejeon (KR); Hoi-Yoon JUNG, Daejeon (KR); Su-Na CHOI, Daejeon (KR); Hyung-Do CHOI, Daejeon (KR); Sung-Hyun HWANG, Daejeon (KR)

(73) Assignee: Electronics and Telecommunications Research Institute, Daejeon (KR)

(21) Appl. No.: 15/811,402

(22) Filed: Nov. 13, 2017

(30) Foreign Application Priority Data
Nov. 16, 2016 (KR) 10-2016-0152385

(51) Int. Cl. H04B 17/345; H04B 3/46

(52) U.S. Cl. CPC H04B 17/345; H04B 3/46

(57) ABSTRACT

Disclosed herein are an apparatus and method for measuring a broadband Passive Intermodulation Distortion (PIMD) signal. The apparatus for measuring a broadband PIMD signal includes a Radio Frequency (RF) processing unit for combining one or more transmission signals into a single output signal and transmitting the output signal to a feeder so as to measure a PIMD signal and for generating a beat frequency signal using the PIMD signal received from the feeder, and a digital processing unit for transferring a control signal required so as to control the RF processing unit, receiving the beat frequency signal, and then measuring a location of a passive element in the feeder in which the PIMD signal has been generated by performing digital signal processing on the beat frequency signal.

### CROSS REFERENCE TO RELATED APPLICATION

This application claims the benefit of Korean Patent Application No. 10-2016-0152385, filed Nov. 16, 2016, which is hereby incorporated by reference in its entirety into this application.

### BACKGROUND OF THE INVENTION

### 1. Technical Field

The present invention relates generally to wireless communication technology and, more particularly, to technology for measuring a passive intermodulation distortion signal.

### 2. Description of the Related Art

Recently, the popularization of smart phones has increased the amount of wireless data that is used, and thus continuous allocation of new frequencies has been required. Mobile communication frequencies that are newly allocated cause installation space for an Electrical Pipe Shaft (EPS) room in a building to be insufficient due to the construction of an increased number of feeders (feeder lines) in the building. Since it is very difficult to install new feeders in practice, a lot of problems arise when new mobile communication services are introduced in a building. In order to solve these problems, mobile carriers (e.g. mobile communication companies or operators) have recently and mutually agreed on the sharing of feeders in each building to reduce the costs of construction of feeders in buildings, resolve insufficiency of space in an EPS room, obviate duplicate investment in feeders in each building, and desirably provide a Multiple-Input Multiple-Output (MIMO) mobile communication service. When mobile carriers use, in common, a feeder in a building to reduce the cost of installation of in-building feeders, Passive Intermodulation Distortion (PIMD) signals originating from passive elements may be generated in the reception frequency band of a base station (i.e. uplink channel). Such PIMD signals may increase the level of noise received by the base station, thus resulting in problems such as terminal call disconnection or excessive terminal power consumption. In order to solve these problems, technology for primarily and precisely measuring locations in a feeder at which the PIMD signals are generated in the entire mobile communication frequency band is essentially required.

Since conventional devices for measuring the locations of generation of PIMD signals are produced to be operated only in a single frequency band, there is a disadvantage in that, in order to find the locations of PIMD signals generated in the entire mobile communication frequency band, multiple PIMD measurement devices must be separately manufactured for respective bands and must then be used.

Meanwhile, Korean Patent Application Publication No. 10-2012-0083768 entitled “Passive Intermodulation Analyzer for Measuring of Faulty Point” relates to an analyzer for analyzing PIMD signals in a high-frequency system. In particular, this patent discloses a PIMD analyzer for measuring faulty Passive Intermodulation (PIM) locations and faulty Voltage Standing Wave Ratio (VSWR) points, which includes a pulse conversion unit, a signal conversion unit, and a signal processing board in the analyzer, and which detect PIMD signals from an RF passive element and an RF module in an RF path between a base station and a repeater for radio communication, measure faulty locations, and measure VSWR values and faulty VSWR points in the RF path.

### SUMMARY OF THE INVENTION

Accordingly, the present invention has been made keeping in mind the above problems occurring in the prior art, and an object of the present invention is to solve a problem in that Passive Intermodulation Distortion (PIMD) signals are generated in a building.

Another object of the present invention is to effectively measure PIMD signals generated in an entire frequency band.

A further object of the present invention is to search for locations at which PIMD signals have been generated in the entire frequency band.

Yet another object of the present invention is to reduce manufacturing costs for a PIMD signal measurement apparatus and effectively operate the PIMD signal measurement apparatus.

In accordance with an aspect of the present invention to accomplish the above objects, there is provided an apparatus for measuring a broadband Passive Intermodulation Distortion (PIMD) signal, including a Radio Frequency (RF) processing unit for combining one or more transmission signals into a single output signal and transmitting the output signal to a feeder so as to measure a PIMD signal and for generating a beat frequency signal using the PIMD signal received from the feeder, and a digital processing unit for transferring a control signal required so as to control the RF processing unit, receiving the beat frequency signal, and then measuring a location of a passive element in the feeder in which the PIMD signal has been generated by performing digital signal processing on the beat frequency signal.

The RF processing unit may include one or more transmission signal generation units for generating one or more transmission signals in response to a control signal corresponding to a transmission signal generation command from the digital processing unit, an RF transmission output unit for classifying the transmission signals according to frequency band, amplifying output levels of the classified signals, filtering respective output level-amplified transmission signals, combining the filtered signals into a single output signal, and transmitting the output signal to the feeder, an RF reception input unit for receiving the PIMD signal from the feeder, dividing the PIMD signal into frequency bands, filtering respective divided signals, combining the filtered signals into a single reception signal, amplifying the reception signal, and then generating a PIMD reception signal, and a PIMD reference signal generator for generating a PIMD reference signal, mixing the PIMD reference signal with the PIMD reception signal, and then generating the beat frequency signal.

The frequency bands may be frequency bands preset for respective mobile communication companies.

The RF processing unit may further include a filter unit for filtering a frequency component of the beat frequency signal, a signal-level controller for controlling a signal level of the filtered beat frequency signal, and an Analog-to-Digital (A/D) converter for converting the beat frequency signal, which is an analog signal, into a digital signal.

The RF transmission output unit may include an RF switch matrix unit for classifying the transmission signals according to frequency band, an amplification unit for amplifying output levels of the transmission signals classified according to frequency band, and a transmission filter unit for filtering respective output level-amplified transmission signals using multiple band-pass filters for respective frequency bands, combining the filtered transmission signals, and then generating the single output signal.

The RF switch matrix unit may include one or more combiners, which are operated in accordance with frequency bands of the transmission signals, and the RF switch matrix unit may be configured to transfer the transmission signals to corresponding combiners that match respective frequency bands and to then classify the transmission signals according to frequency band.

The RF reception input unit may include a reception filter unit for dividing the received PIMD signal into frequency bands, filtering respective divided signals using multiple band-pass filters, combining the filtered signals into a single reception signal, and outputting the reception signal, and a low-noise amplification unit for generating the PIMD reception signal by amplifying the reception signal.

The digital processing unit may determine the location of the passive element using information about a distance at which the PIMD signal has been generated and information about a magnitude of the PIMD signal, the distance information and the magnitude information being extracted from the beat frequency signal.

In accordance with an aspect of the present invention to accomplish the above objects, there is provided a method for measuring a broadband PIMD signal, the method being performed using an apparatus for measuring a PIMD signal, the method including generating a single output signal by combining one or more transmission signals that are generated to measure a PIMD signal, transmitting the output signal to a feeder, receiving the PIMD signal from the feeder, and measuring a location of a passive element in the feeder in which the PIMD signal has been generated by utilizing the received PIMD signal.

Generating the single output signal may include generating one or more transmission signals, classifying the generated transmission signals according to frequency band, filtering respective classified transmission signals for respective frequency bands, and combining the filtered transmission signals into the single output signal.

The frequency bands may be frequency bands preset for respective mobile communication companies.

Classifying the generated transmission signals may be performed using one or more combiners, which are operated in accordance with the frequency bands of the transmission signals, in such a way as to respectively transfer the transmission signals to corresponding combiners that match respective frequency bands and to then classify the transmission signals according to frequency band.

Filtering the classified transmission signals may be configured to amplify output levels of the transmission signals, classified according to frequency band, and to filter respective output level-amplified transmission signals using multiple band-pass filters for respective frequency bands.

Receiving the PIMD signal may include dividing the received PIMD signal into the frequency bands, filtering respective divided signals using multiple band-pass filters, combining the filtered signals into a single reception signal, and generating a PIMD reception signal by amplifying the reception signal.

Measuring the location of the passive element may include generating a beat frequency signal by mixing the PIMD reception signal with a PIMD reference signal, converting the beat frequency signal into a digital signal, and measuring the location of the passive element by performing digital signal processing on the beat frequency signal converted into the digital signal.

Measuring the location of the passive element by performing digital signal processing on the beat frequency signal may be configured to determine the location of the passive element using information about a distance at which the PIMD signal has been generated and information about a magnitude of the PIMD signal, the distance information and the magnitude information being extracted from the beat frequency signal.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating an apparatus for measuring a broadband PIMD signal according to an embodiment of the present invention;

FIG. 2 is a block diagram illustrating in detail an example of the RF transmission output unit illustrated in FIG. 1;

FIG. 3 is a block diagram illustrating in detail an example of the RF reception input unit illustrated in FIG. 1;

FIG. 4 is an operation flowchart illustrating a method for measuring a broadband PIMD signal according to an embodiment of the present invention;

FIG. 5 is an operation flowchart illustrating in detail an example of the signal generation step illustrated in FIG. 4;

FIG. 6 is an operation flowchart illustrating in detail an example of the signal reception step illustrated in FIG. 4;

FIG. 7 is an operation flowchart illustrating in detail an example of the location measurement step illustrated in FIG. 4; and

FIG. 8 is a block diagram illustrating a computer system according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

In the present specification, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added.

Hereinafter, embodiments of the present invention will be described in detail with reference to the attached drawings.

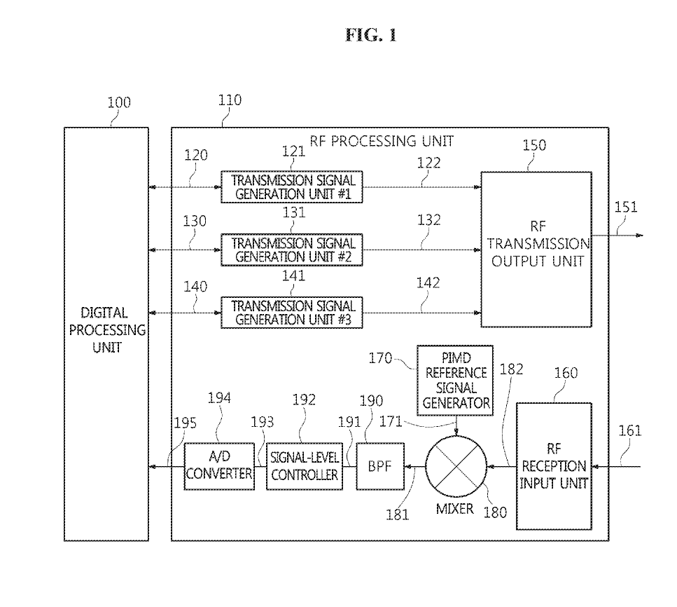

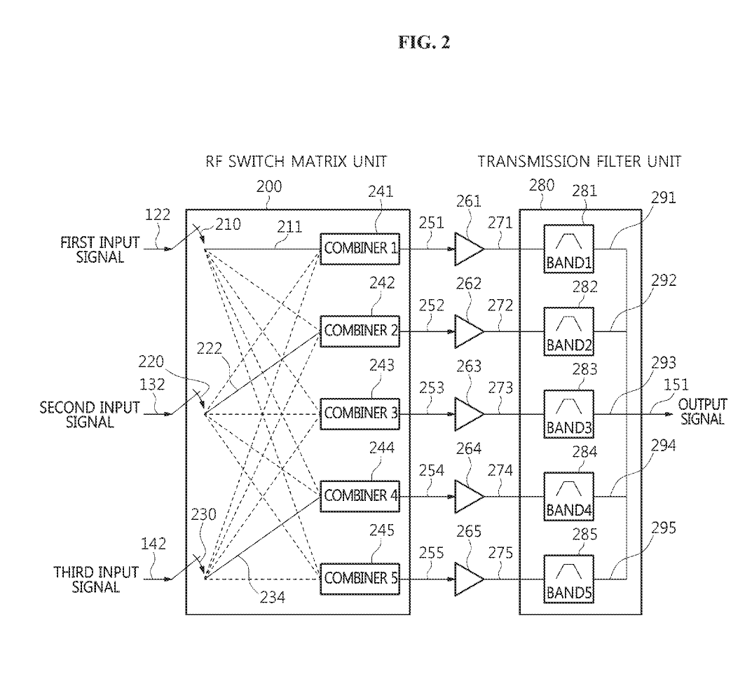

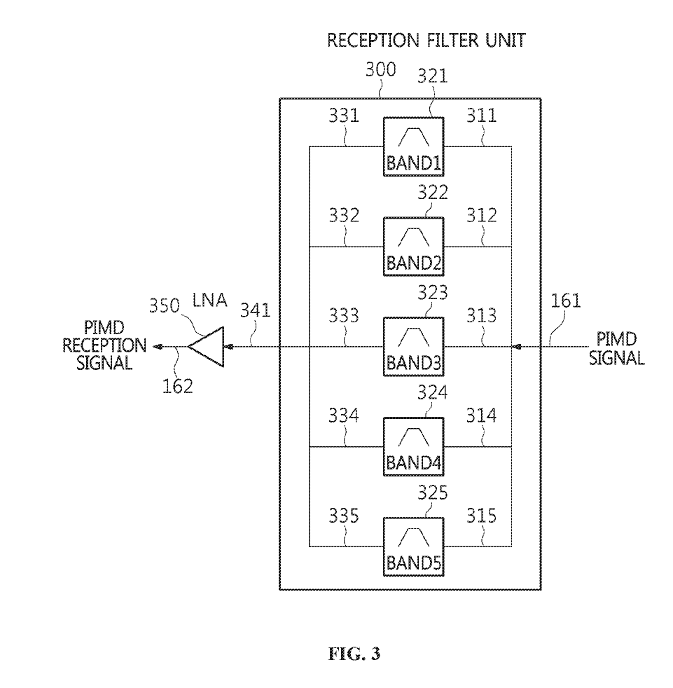

FIG. 1 is a block diagram illustrating an apparatus for measuring a broadband PIMD signal according to an embodiment of the present invention. FIG. 2 is a block diagram illustrating in detail an example of the RF transmission output unit illustrated in FIG. 1. FIG. 3 is a block diagram illustrating in detail an example of the RF reception input unit illustrated in FIG. 1.

Referring to FIG. 1, an apparatus for measuring a broadband Passive Intermodulation Distortion (PIMD) signal according to an embodiment of the present invention includes a digital processing unit 100 and a Radio Frequency (RF) processing unit 110.

The RF processing unit 110 may combine one or more transmission signals into a single output signal and transmit the single output signal to a feeder (feeder line) so as to measure a PIMD signal, and may generate a beat frequency signal using the PIMD signal received from the feeder.

The digital processing unit 100 may transfer a control signal required to control the RF processing unit 110, may receive the beat frequency signal, and may then measure the location of a passive element in the feeder in which the PIMD signal has been generated by performing digital signal processing on the beat frequency signal.

The RF processing unit 110 may include one or more transmission signal generation units 121, 131, and 141, an RF transmission output unit 150, an RF reception input unit 160, a PIMD reference signal generator 170, a filter unit 190 (e.g. a band-pass filter: BPF), a signal-level controller 192, and an analog-to-digital (A/D) converter 194.

The one or more transmission signal generation units 121, 131, and 141 may generate one or more transmission signals in response to a control signal corresponding to a transmission signal generation command from the digital processing unit 100.

The RF transmission output unit 150 may classify the transmission signals according to frequency band, may amplify the output levels of the classified signals, may filter respective output level-amplified transmission signals, may combine the filtered signals into a single output signal, and may transmit the output signal to the feeder.

Here, the frequency bands may be frequency bands that are preset for respective mobile communication companies.

TABLE 1
Examples of mobile communication frequencies used by mobile communication company A

| | Band (MHz) | | | |
|---|---|---|---|---|
| Group | Uplink | | Downlink | |
| (1) | 819 | 824 | 864 | 869 |
| (2) | 904.3 | 914.3 | 949.3 | 959.3 |
| (3) | 1735 | 1740 | 1830 | 1860 |
| | 1745 | 1765 | | |
| (4) | 1960 | 1970 | 2150 | 2160 |
| | 1970 | 1980 | 2160 | 2170 |

Examples of mobile communication frequencies used by mobile communication company B

| | Band (MHz) | | | |
|---|---|---|---|---|
| Group | Uplink | | Downlink | |
| (1) | 824 | 829 | 869 | 874 |
| | 829 | 839 | 874 | 884 |
| (3) | 1715 | 1725 | 1810 | 1830 |
| | 1730 | 1735 | | |
| (4) | 1940 | 1960 | 2130 | 2150 |
| (5) | 2500 | 2520 | 2620 | 2640 |
| | 2540 | 2560 | 2660 | 2670 |

Examples of mobile communication frequencies used by mobile communication company C

| | Band (MHz) | | | |
|---|---|---|---|---|
| Group | Uplink | | Downlink | |
| (1) | 839 | 849 | 884 | 894 |
| (3) | 1770 | 1780 | 1860 | 1870 |
| (4) | 1920 | 1940 | 2110 | 2130 |
| (5) | 2520 | 2540 | 2640 | 2660 |

For example, it can be seen that Table 1 shows examples of frequencies used for uplink and downlink transmission by respective mobile communication companies to provide mobile communication services.

In the present invention, in order to effectively measure PIMD signals that may be generated in the entire frequency band that is currently used by mobile communication companies, the entire mobile communication frequency band is divided into five groups, as shown in Table 1. That is, frequency bands may be classified such that an uplink frequency band is divided into five groups and, in the same way, a downlink frequency band is divided into five groups. In this case, division and classification of frequency bands may vary according to the frequency band used by each mobile communication company.

Here, the Band-Pass Filter (BPF) and the High-Power Amplifier (HPA) of the PIMD signal measurement apparatus according to the embodiment of the present invention may be produced to be individually operated in the frequency bands grouped and classified in this way.

Further, the filter unit used in the PIMD signal measurement apparatus may be a cavity filter.

The RF reception input unit 160 may receive a PIMD signal from the feeder, may divide the PIMD signal into frequency bands, may filter respective divided signals, may combine the filtered signals into a single reception signal, may amplify the reception signal, and may then generate a PIMD reception signal.

Referring to FIG. 2, the RF transmission output unit 150 according to an embodiment of the present invention may include an RF switch matrix unit 200, amplification units (e.g. High-Power Amplifiers: HPA) 261, 262, 263, 264, and 265, and a transmission filter unit 280.

The RF switch matrix unit 200 may classify transmission signals according to frequency band.

Here, the RF switch matrix unit 200 may include one or more combiners 241, 242, 243, 244, and 245, which are operated in accordance with the frequency bands of the transmission signals.

The RF switch matrix unit 200 may respectively transfer the transmission signals to the corresponding combiners 241, 242, 243, 244, and 245 that match respective frequency bands, and may then classify the transmission signals according to frequency band.

The amplification units 261, 262, 263, 264, and 265 may amplify the output levels of the transmission signals that have been classified according to frequency band.

The transmission filter unit 280 may filter respective output level-amplified transmission signals using multiple band-pass filters 281, 282, 283, 284, and 285 for respective frequency bands, and may combine the filtered transmission signals to generate a single output signal.

For example, when the digital processing unit 100 transfers a control signal including a transmission signal generation command to the first transmission signal generation unit 121 of the RF processing unit 110, the first transmission signal generation unit 121 may generate a Frequency-Modulated Continuous Wave (FMCW) or Continuous Wave (CW) signal, and may transfer the generated signal to the RF transmission output unit 150. Similarly, when the digital processing unit 100 transfers a control signal including a transmission signal generation command to the second transmission signal generation unit 131 of the RF processing unit 110, the second transmission signal generation unit 131 may generate an FMCW or CW signal, and may transfer the generated signal to the RF transmission output unit 150. When the digital processing unit 100 transfers a control signal including a transmission signal generation command to the third transmission signal generation unit 141 of the RF processing unit 110, the third transmission signal generation unit 141 may generate an FMCW or CW signal, and may transfer the generated signal to the RF transmission output unit 150.

Here, whether to generate the transmission signal corresponding to the FMCW signal or the CW signal may be determined using a method for generating a transmission signal in such a way as to be directly determined by the transmission signal generation unit 121, 131, or 141, based on received control information, and a method for generating a transmission signal in such a way as to separately design and manufacture a transmission signal generation unit for generating an FMCW signal and a transmission signal generation unit for generating a CW signal based on hardware.

Further, although not illustrated in detail in FIG. 1, each of the first transmission signal generation unit 121, the second transmission signal generation unit 131, and the third transmission signal generation unit 141 may additionally include a signal generator for generating an FMCW signal or a CW signal, a signal-level controller, a multiplier, etc. The three FMCW or CW signals 122, 132, and 142, which are input to the RF transmission output unit 150, may be subjected to transmission output level control and filtering, and may then be output as an output signal 151 through a single output port.

Further, referring to Table 1, it is assumed that the first input signal 122 is operated in a frequency band corresponding to group 1, the second input signal 132 is operated in a frequency band corresponding to group 2, and the third input signal 142 is operated in a frequency band corresponding to group 4. In this case, a first switch 210 in the RF switch matrix unit 200 may select a first line 211 from among five lines, and may transfer the first input signal to the first line 211. A second switch 220 may select a second line 222 from among the five lines, and may transfer the second input signal to the second line 222. The third switch 230 may select a fourth line 234 from among the five lines, and may transfer the third input signal to the fourth line 234. When the signals transferred in this way pass through the five signal combiners 241, 242, 243, 244, and 245, the transferred signals may be classified into five frequency band signal components 251, 252, 253, 254, and 255. The first frequency band signal 251 may pass through the HPA 261 produced for a first frequency band, and then the transmission output level of the first frequency band signal 251 may be amplified to that of an output signal 271. Thereafter, the amplified output signal may pass through the first filter 281 in the transmission filter unit 280, and may then be filtered and output as an output signal 291. Similarly, the second frequency band signal 252 may pass through the HPA 262 produced for a second frequency band, and then the transmission output level of the second frequency band signal 252 may be amplified to that of an output signal 272. Thereafter, the amplified output signal may pass through the second filter 282 in the transmission filter unit 280, and may then be filtered and output as an output signal 292. The third frequency band signal 253 may pass through the HPA 263 produced for a third frequency band, and then the transmission output level of the third frequency band signal 253 may be amplified to that of an output signal 273. Thereafter, the amplified output signal may pass through the third filter 283 in the transmission filter unit 280, and may then be filtered and output as an output signal 293. The fourth frequency band signal 254 may pass through the HPA 264 produced for a fourth frequency band, and then the transmission output level of the fourth frequency band signal 254 may be amplified to that of an output signal 274. Thereafter, the amplified output signal may pass through the fourth filter 284 in the transmission filter unit 280, and may then be filtered and output as an output signal 294. Finally, the fifth frequency band signal 255 may pass through the HPA 265 produced for a fifth frequency band, and then the transmission output level of the fifth frequency band signal 255 may be amplified to that of an output signal 275. Thereafter, the amplified output signal may pass through the fifth filter 285 in the transmission filter unit 280, and may then be filtered and output as an output signal 295. The signals produced for respective frequency bands in this way may be combined into a single signal, and thus the single signal may be transmitted as the output signal 151 of the PIMD signal measurement apparatus to the feeder. In the present embodiment, three types of signals 291, 292, and 294, output after passing through the first filter 281, the second filter 282, and the fourth filter 284, respectively, may be combined, and thus a resulting combined signal may be transmitted as the output signal 151 to the feeder.

Referring to FIG. 3, the RF reception input unit 160 according to an embodiment of the present invention may include a reception filter unit 300 and a low-noise amplification unit (e.g. a Low-Noise Amplifier: LNA) 350.

The reception filter unit 300 may divide a received PIMD signal into frequency bands, may filter respective divided signals using multiple band-pass filters 321, 322, 323, 324, and 325, may combine the filtered signals into a single reception signal, and may output the single reception signal.

The low-noise amplification unit 350 may generate a PIMD reception signal by amplifying the reception signal.

The PIMD reference signal generator 170 may generate a PIMD reference signal, mix the PIMD reference signal with the PIMD reception signal, and then generate a beat frequency signal.

In FIG. 1, the PIMD reference signal generator 170 may generate the PIMD reference signal while maintaining a frequency offset of f_{IF} from the received PIMD signal.

Here, since a beat frequency signal 181, output after passing through the mixer 180, is generated in an Intermediate Frequency (IF) band, it may be filtered using the band-pass filter 190 to extract a desired beat frequency component.

However, when the PIMD reference signal generator 170 generates a signal in the same frequency band as the received PIMD signal, the beat frequency signal, output after passing through the mixer 180, is generated in a baseband, and thus the beat frequency signal may be filtered using a Low-Pass Filter (LPF) to extract a desired beat frequency component.

The filter unit 190 may be a Band-Pass Filter (BPF) or a Low-Pass Filter (LPF), and may filter the frequency component of the beat frequency signal.

The signal-level controller 192 may control the signal level of the filtered beat frequency signal.

The A/D converter 194 may convert the beat frequency signal, which is an analog signal, into a digital signal.

Since the beat frequency signal generated in this way has information about the distance to the PIMD signal and information about the magnitude of the PIMD signal, the location at which the PIMD signal has been generated may be determined through signal processing within the digital processing unit 100.

That is, the digital processing unit 100 may determine the location of the passive element using the information about the distance at which the PIMD signal was generated and the information about the magnitude of the PIMD signal, the distance information and the magnitude information being extracted from the beat frequency signal.

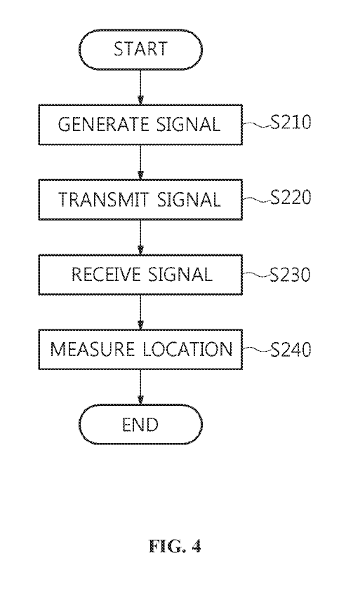

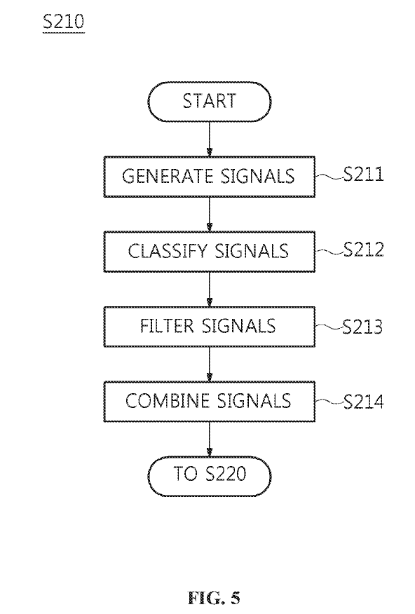

FIG. 4 is an operation flowchart illustrating a method for measuring a broadband PIMD signal according to an embodiment of the present invention. FIGS. 5 to 7 are operation flowcharts illustrating in detail examples of respective steps illustrated in FIG. 4.

Referring to FIG. 4, the broadband PIMD signal measurement method according to an embodiment of the present invention may generate a signal at step S210.

That is, at step S210, one or more transmission signals generated to measure a PIMD signal may be combined with each other, and thus a single output signal may be generated.

Here, in a procedure at step S210, signals may be generated first at step S211.

That is, at step S211, one or more transmission signals may be generated.

Further, in the procedure at step S210, the signals may be classified at step S212.

That is, at step S212, the generated transmission signals may be classified according to frequency band.

Here, step S212 may be performed using one or more combiners 241, 242, 243, 244, and 245, which are operated in accordance with the frequency bands of the transmission signals, in such a way as to respectively transfer the transmission signals to the corresponding combiners 241, 242, 243, 244, and 245 that match respective frequency bands and to then classify the transmission signals according to frequency band.

Here, the frequency bands may be frequency bands that are preset for respective mobile communication companies.

Further, in the procedure at step S210, the signals may be filtered at step S213.

That is, at step S213, the classified transmission signals may be filtered for respective frequency bands.

Here, at step S213, the output levels of the transmission signals classified according to frequency band may be amplified, and respective output level-amplified transmission signals may be filtered using multiple band-pass filters 281, 282, 283, 284, and 285 for respective frequency bands.

Further, in the procedure at step S210, the signals may be combined with each other at step S214.

In detail, at step S214, the filtered transmission signals may be combined into the single output signal.

Further, the broadband PIMD signal measurement method according to the embodiment of the present invention may transmit the signal at step S220.

That is, at step S220, the combined output signal may be transmitted to the feeder to measure a PIMD signal.

Next, the broadband PIMD signal measurement method according to the embodiment of the present invention may receive a signal at step S230.

In detail, at step S230, the PIMD signal may be received from the feeder.

Here, in a procedure at step S230, the signal may be divided first at step S231.

That is, at step S231, the received PIMD signal may be divided into the frequency bands.

Further, in the procedure at step S230, the divided signals may be filtered at step S232.

That is, at step S232, the divided signals may be filtered using multiple band-pass filters 321, 322, 323, 324, and 325.

Further, in the procedure at step S230, the signals may be combined with each other at step S233.

That is, at step S233, the filtered signals may be combined into a single reception signal.

Further, in the procedure at step S230, a certain signal may be generated at step S234.

That is, at step S234, a PIMD reception signal may be generated by amplifying the reception signal.

Next, the broadband PIMD signal measurement method according to the embodiment of the present invention may measure a location at step S240.

In detail, at step S240, the location of a passive element in the feeder in which the PIMD signal has been generated may be measured using the received PIMD signal.

In a procedure at step S240, a beat frequency signal may be generated first at step S241.

In detail, at step S241, the beat frequency signal may be generated by mixing the PIMD reception signal with a PIMD reference signal.

Further, in the procedure at step S240, the generated signal may be converted into a digital signal at step S242.

That is, at step S242, the beat frequency signal may be converted into a digital signal.

Also, in the procedure at step S240, the location of the passive element may be measured at step S243.

That is, at step S243, the location of the passive element may be measured by performing digital signal processing on the beat frequency signal that has been converted into the digital signal.

In detail, at step S243, the location of the passive element may be determined using information about the distance at which the PIMD signal has been generated and information about the magnitude of the PIMD signal, the distance information and the magnitude information being extracted from the beat frequency signal.

FIG. 5 is an operation flowchart illustrating in detail an example of the signal generation step illustrated in FIG. 4.

Referring to FIG. 5, in a procedure at step S210, signals may be generated first at step S211.

In detail, at step S211, one or more transmission signals may be generated.

Further, in the procedure at step S210, the signals may be classified at step S212.

That is, at step S212, the generated transmission signals may be classified according to frequency band.

Here, step S212 may be performed using one or more combiners 241, 242, 243, 244, and 245, which are operated in accordance with the frequency bands of the transmission signals, in such a way as to respectively transfer the transmission signals to the corresponding combiners 241, 242, 243, 244, and 245 that match respective frequency bands and to then classify the transmission signals according to frequency band.

Here, the frequency bands may be frequency bands that are preset for respective mobile communication companies.

Further, in the procedure at step S210, the signals may be filtered at step S213.

That is, at step S213, the classified transmission signals may be filtered for respective frequency bands.

Here, at step S213, the output levels of the transmission signals classified according to frequency band may be amplified, and respective output level-amplified transmission signals may be filtered using multiple band-pass filters 281, 282, 283, 284, and 285 for respective frequency bands.

Further, in the procedure at step S210, the signals may be combined with each other at step S214.

In detail, at step S214, the filtered transmission signals may be combined into the single output signal.

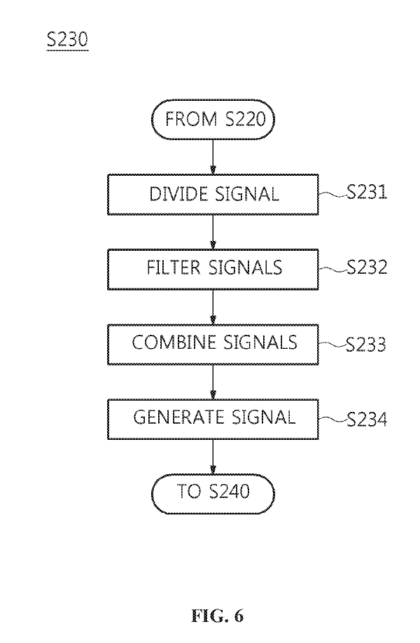

FIG. 6 is an operation flowchart illustrating in detail an example of the signal reception step illustrated in FIG. 4.

Referring to FIG. 6, in a procedure at step S230, the signal may be divided first at step S231.

In detail, at step S231, the received PIMD signal may be divided into frequency bands.

Further, in the procedure at step S230, the divided signals may be filtered at step S232.

That is, at step S232, the divided signals may be filtered using multiple band-pass filters 321, 322, 323, 324, and 325.

Further, in the procedure at step S230, the signals may be combined with each other at step S233.

That is, at step S233, the filtered signals may be combined into a single reception signal.

Further, in the procedure at step S230, a certain signal may be generated at step S234.

In detail, at step S234, a PIMD reception signal may be generated by amplifying the reception signal.

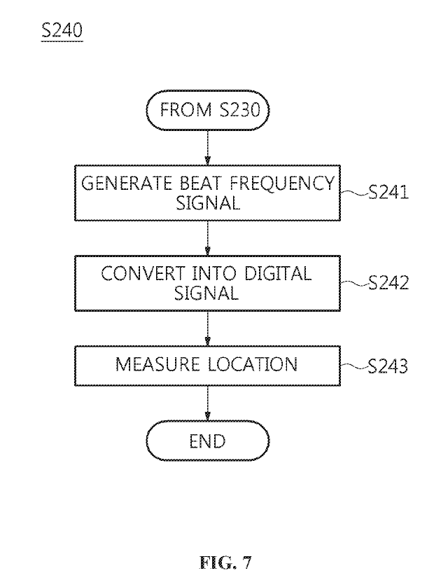

FIG. 7 is an operation flowchart illustrating in detail an example of the location measurement step illustrated in FIG. 4.

Referring to FIG. 7, in a procedure at step S240, a beat frequency signal may be generated first at step S241.

In detail, at step S241, the beat frequency signal may be generated by mixing the PIMD reception signal with a PIMD reference signal.

Further, in the procedure at step S240, the generated signal may be converted into a digital signal at step S242.

That is, at step S242, the beat frequency signal may be converted into a digital signal.

Also, in the procedure at step S240, the location of the passive element may be measured at step S243.

That is, at step S243, the location of the passive element may be measured by performing digital signal processing on the beat frequency signal that has been converted into the digital signal.

In detail, at step S243, the location of the passive element may be determined using information about the distance at which the PIMD signal has been generated and information about the magnitude of the PIMD signal, the distance information and the magnitude information being extracted from the beat frequency signal.

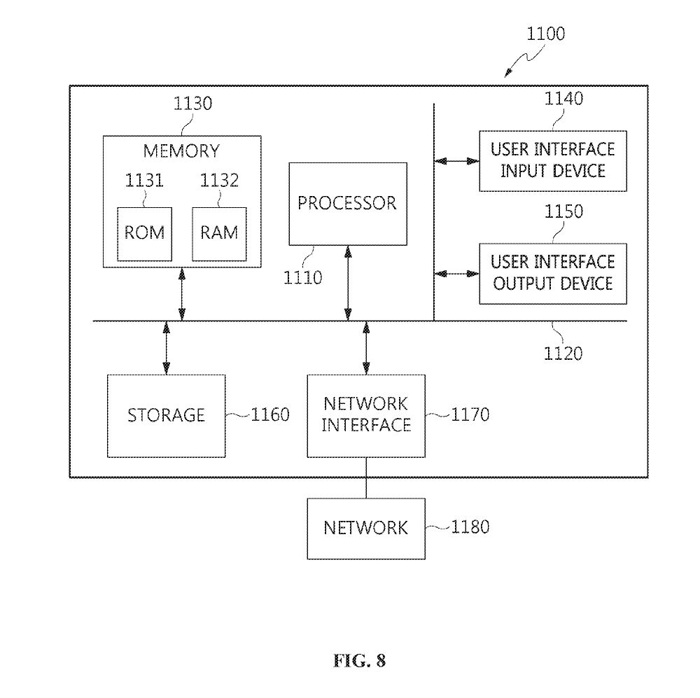

FIG. 8 is a block diagram illustrating a computer system according to an embodiment of the present invention.

Referring to FIG. 8, an embodiment of the present invention may be implemented in a computer system 1100, such as a computer-readable storage medium. As illustrated in FIG. 6, the computer system 1100 may include one or more processors 1110, memory 1130, a user interface input device 1140, a user interface output device 1150, and storage 1160, which communicate with each other through a bus 1120. The computer system 1100 may further include a network interface 1170 connected to a network 1180. Each of the processors 1110 may be a CPU or a semiconductor device for executing processing instructions stored in the memory 1130 or the storage 1160. Each of the memory 1130 and the storage 1160 may be any of various types of volatile or nonvolatile storage media. For example, the memory 1130 may include Read-Only Memory (ROM) 1131 or Random Access Memory (RAM) 1132.

Accordingly, the present invention may solve a problem in that Passive Intermodulation Distortion (PIMD) signals are generated in a building.

Further, the present invention may effectively measure PIMD signals generated in an entire frequency band.

Furthermore, the present invention may search for locations at which PIMD signals have been generated in the entire frequency band.

In addition, the present invention may present a scheme for reducing manufacturing costs for a PIMD signal measurement apparatus and effectively operating the PIMD signal measurement apparatus.

As described above, in the apparatus and method for measuring a broadband PIMD signal according to the present invention, the configurations and schemes in the above-described embodiments are not limitedly applied, and some or all of the above embodiments can be selectively combined and configured such that various modifications are possible.

What is claimed is:

1. An apparatus for measuring a broadband Passive Intermodulation Distortion (PIMD) signal, comprising:
a Radio Frequency (RF) processing unit for combining one or more transmission signals into a single output signal and transmitting the output signal to a feeder so as to measure a PIMD signal and for generating a beat frequency signal using the PIMD signal received from the feeder; and
a digital processing unit for transferring a control signal required so as to control the RF processing unit, receiving the beat frequency signal, and then measuring a location of a passive element in the feeder in which the PIMD signal has been generated by performing digital signal processing on the beat frequency signal.

2. The apparatus of claim 1, wherein the RF processing unit comprises:
one or more transmission signal generation units for generating one or more transmission signals in response to a control signal corresponding to a transmission signal generation command from the digital processing unit;
an RF transmission output unit for classifying the transmission signals according to frequency band, amplifying output levels of the classified signals, filtering respective output level-amplified transmission signals, combining the filtered signals into a single output signal, and transmitting the output signal to the feeder;
an RF reception input unit for receiving the PIMD signal from the feeder, dividing the PIMD signal into frequency bands, filtering respective divided signals, combining the filtered signals into a single reception signal, amplifying the reception signal, and then generating a PIMD reception signal; and
a PIMD reference signal generator for generating a PIMD reference signal, mixing the PIMD reference signal with the PIMD reception signal, and then generating the beat frequency signal.

3. The apparatus of claim 2, wherein the frequency bands are frequency bands preset for respective mobile communication companies.

4. The apparatus of claim 3, wherein the RF processing unit further comprises:
a filter unit for filtering a frequency component of the beat frequency signal;
a signal-level controller for controlling a signal level of the filtered beat frequency signal; and
an Analog-to-Digital (A/D) converter for converting the beat frequency signal, which is an analog signal, into a digital signal.

5. The apparatus of claim 4, wherein the RF transmission output unit comprises:
an RF switch matrix unit for classifying the transmission signals according to frequency band;
an amplification unit for amplifying output levels of the transmission signals classified according to frequency band; and
a transmission filter unit for filtering respective output level-amplified transmission signals using multiple band-pass filters for respective frequency bands, combining the filtered transmission signals, and then generating the single output signal.

6. The apparatus of claim 5, wherein:
the RF switch matrix unit comprises one or more combiners that are operated in accordance with frequency bands of the transmission signals, and
the RF switch matrix unit is configured to respectively transfer the transmission signals to corresponding combiners that match respective frequency bands and to then classify the transmission signals according to frequency band.

7. The apparatus of claim 2, wherein the RF reception input unit comprises:
a reception filter unit for dividing the received PIMD signal into frequency bands, filtering respective divided signals using multiple band-pass filters, combining the filtered signals into a single reception signal, and outputting the reception signal; and
a low-noise amplification unit for generating the PIMD reception signal by amplifying the reception signal.

8. The apparatus of claim 7, wherein the digital processing unit determines the location of the passive element using information about a distance at which the PIMD signal has been generated and information about a magnitude of the PIMD signal, the distance information and the magnitude information being extracted from the beat frequency signal.

9. A method for measuring a broadband PIMD signal, the method being performed using an apparatus for measuring a PIMD signal, the method comprising:
generating a single output signal by combining one or more transmission signals that are generated to measure a PIMD signal;
transmitting the output signal to a feeder;
receiving the PIMD signal from the feeder; and
measuring a location of a passive element in the feeder in which the PIMD signal has been generated by utilizing the received PIMD signal.

10. The method of claim 9, wherein generating the single output signal comprises:
generating one or more transmission signals;
classifying the generated transmission signals according to frequency band;
filtering respective classified transmission signals for respective frequency bands; and
combining the filtered transmission signals into the single output signal.

11. The method of claim 10, wherein the frequency bands are frequency bands preset for respective mobile communication companies.

12. The method of claim 11, wherein classifying the generated transmission signals is performed using one or more combiners, which are operated in accordance with the frequency bands of the transmission signals, in such a way as to respectively transfer the transmission signals to corresponding combiners that match respective frequency bands and to then classify the transmission signals according to frequency band.

13. The method of claim 12, wherein filtering the classified transmission signals is configured to amplify output levels of the transmission signals, classified according to frequency band, and to filter respective output level-amplified transmission signals using multiple band-pass filters for respective frequency bands.

14. The method of claim 13, wherein receiving the PIMD signal comprises:
dividing the received PIMD signal into the frequency bands;
filtering respective divided signals using multiple band-pass filters;
combining the filtered signals into a single reception signal; and
generating a PIMD reception signal by amplifying the reception signal.

15. The method of claim 14, wherein measuring the location of the passive element comprises:
generating a beat frequency signal by mixing the PIMD reception signal with a PIMD reference signal;
converting the beat frequency signal into a digital signal; and
measuring the location of the passive element by performing digital signal processing on the beat frequency signal converted into the digital signal.

16. The method of claim 15, wherein measuring the location of the passive element by performing digital signal processing on the beat frequency signal is configured to determine the location of the passive element using information about a distance at which the PIMD signal has been generated and information about a magnitude of the PIMD signal, the distance information and the magnitude information being extracted from the beat frequency signal.
